(19) United States
(12) Patent Application Publication
(10) Pub. No.: US 2013/0050903 A1
(43) Pub. Date: Feb. 28, 2013

(54) ELECTRODES, AND ELECTROCHEMICAL CAPACITORS INCLUDING THE SAME

(71) Applicants: Hak Kwan KIM, Seoul (KR); Jun Hee Bae, Seoul (KR); Bae Kyun Kim, Gyeonggi-do (KR); Ho Jin Yun, Gyeonggi-do (KR)

(72) Inventors: Hak Kwan KIM, Seoul (KR); Jun Hee Bae, Seoul (KR); Bae Kyun Kim, Gyeonggi-do (KR); Ho Jin Yun, Gyeonggi-do (KR)

(73) Assignee: SAMSUNG ELECTRO-MECHANICS CO., LTD., Suwon (KR)

(21) Appl. No.: 13/468,491

(22) Filed: May 10, 2012

(30) Foreign Application Priority Data
Aug. 30, 2011 (KR) 10-2011-0087371

(51) Int. Cl. H01G 9/058; H01G 9/042

(52) U.S. Cl. 361/502; 361/503; 361/523

(57) ABSTRACT

Electrodes and electrochemical capacitors including the same including an electrode active material layer having two layers or more formed on a current collector, wherein the electrode active material layer has a gradient of the specific surface area value to the electric conductivity along a thickness direction of a current collector. Exemplary embodiments manufacture the electrodes having the gradient of the specific surface area value to the electricity conductivity along the thickness direction of the current collector by forming the electrode active material layer having compositions in which a kind of electrode active materials and conductive materials are different along the thickness direction of the current collector. The exemplary embodiments can increase the capacitance of the electrochemical capacitor including the electrode and lower the electric resistance thereof, by appropriately controlling the resistance and capacitance value of the electrode.

### CROSS REFERENCE(S) TO RELATED APPLICATIONS

This application claims the benefit under 35 U.S.C. Section 119 of Korean Patent Application Serial No. 10-2011-0087371, entitled “Electrodes, and Electrochemical Capacitors Including the Same” filed on Aug. 30, 2011, which is hereby incorporated by reference in its entirety into this application.

### BACKGROUND OF THE INVENTION

1. Technical Field

The present invention relates to electrodes and electrochemical capacitors including the same.

2. Description of the Related Art

Generally, a supercapacitor mainly uses electrostatic characteristics, such that the supercapacitor may have a rechargeable frequency hundreds of thousands times as compared with a battery using an electrochemical reaction, be semi-permanently used, perform charging and discharging at high speed, and have output density several tens of times higher than the battery. Therefore, application fields of the supercapacitor have been gradually expanded due to the characteristics of the supercapacitor that cannot be implemented by the existing battery. In particular, the use of the supercapacitor has been gradually increased in a next-generation environmentally friendly vehicle field such as an electric car, a fuel cell vehicle, or the like.

The supercapacitor, which is as an auxiliary energy storage device, is used together with the battery, such that the supercapacitor is responsible for an instant supply of energy and the battery is responsible for a general supply of energy of a vehicle, thereby improving general efficiency of a vehicle system, extending the lifespan of an energy storage system, or the like. In addition, the supercapacitor may be used as a main auxiliary power supply in heavy equipment such as an excavator, an energy storage device such as UPS, wind power, solar power, and portable electronic components such as a mobile phone, a moving picture recorder, and the importance and usage thereof have been gradually increased.

The supercapacitor may be largely classified into three types, that is, an electrical double layer capacitor (EDLC), a pseudo-capacitor, and a hybrid capacitor that is a combination thereof.

Among others, the electrical double layer capacitor accumulates charges by generating an electrical double layer on a surface thereof and the pseudo-capacitor accumulates charges by an oxidation-reduction reaction of metal oxides used as an active material.

In the case of the most frequently used electrical double layer capacitor, an environmentally friendly carbon material having excellent safety is used as an electrode material.

In addition, in order to improve conductivity, a conductive material having relatively excellent electric conductivity as compared with other carbon materials is added as a conductive material.

Next, FIG. 1 shows a general structure of the supercapacitor. Referring to FIG. 1, a cathode 10 and an anode 20 of electrode active material layers 12 and 22 using a porous carbon material 13 that are formed on cathode and anode current collectors 11 and 21 are electrically disconnected from each other due to a separation membrane 30. In addition, an electrolyte 40 is filled between two electrodes of the cathode 10 and the anode 20 and the current collectors 11 and 12 serve to effectively charge or discharge charges in electrodes and are manufactured by being finally sealed 50.

Meanwhile, activated carbon that is a porous carbon material used as the electrode active material of the supercapacitor is a porous material having fine pores and has a wide specific surface area. Therefore, if negative (−) voltage is applied to the electrodes (cathode) 10 using the activated carbon, positive (+) ions generated by being dissociated from the electrolyte enter pores of the activated carbon electrode to form a positive (+) layer, which may charge charges while forming the electrical double layer together with a negative (−) layer formed at an interface of the activated carbon electrode.

In this case, the capacity of the supercapacitor largely depends on the structure and the physical properties of the electrode and the supercapacitor requires characteristics such as a large specific surface area and, small internal resistance and contact resistance inherent to a material and needs to be made of high-density carbon material.

The important matters are that the resistance is increased and the capacitance is reduced as the density of the electrode active material is reduced. As such, the density, the resistance, and the capacitance of the electrode manufactured using the active material and the conductive material are closely connected with each other.

Generally, when the contents of the conductive material is increased, the resistance is reduced due to the high electric conductivity of the conductive material but the amount of active material such as activated carbon is also reduced and thus, the capacitance is also reduced. To the contrary, when the content of the high-density active material is increased, the capacitance is increased but the resistance is also increased. As a result, it is known that it is important to find an appropriate ratio (for example, about 8:1) of the conductive material to the active material.

In other words, when the density of the electrode is reduced, the active material does not effectively contact the conductive material, such that ESR may be increased and capacitance is reduced. Therefore, an attempt to find an improved method therefore has been still continued.

Generally, the resistance of the electrode layer is high as being far away from a thickness direction of the current collector and the resistance thereof is reduced as being close thereto. Therefore, as the thickness of the electrode is thicker, the capacitance is increased but the non-uniformity of the electric conductivity in the thickness direction of the electrode layer is increased. As a result, when the high-efficiency charging and discharging is performed, only the electrode active material near the current collector is used but the electrode active material spaced apart from the thickness direction of the current collector is not sufficiently used.

Therefore, the sufficient energy density cannot be achieved. Further, only the active material near the current collector is used and therefore, the electrode active material is locally deteriorated, thereby significantly deteriorating the cycle characteristics.

### SUMMARY OF THE INVENTION

An object of the present invention is to provide electrodes for electrochemical capacitors capable of increasing a filling rate of an electrode active material and improving conductivity by changing an electrode active material and a content and a kind of a conductive material in a thickness direction of a current collector so as to form a multi-layer electrode active material layer.

Further, another object of the present invention is to provide an electrochemical capacitor including electrodes.

According to an exemplary embodiment of the present invention, there is provided an electrode, including: an electrode active material layer having two layers or more formed on a current collector, wherein the electrode active material layer has a gradient of a specific surface area value to electric conductivity along a thickness direction of the current collector.

The electric conductivity of the electrode active material layer may be increased and the specific surface area value may be reduced, as being far away from the thickness direction of the current collector.

The gradient of the specific surface area value to the electric conductivity and the of the electrode active material layer may be formed based on the electrode active material layer formed at about 30 μm from the current collector along the thickness direction of the current collector.

The electrode active material layer formed in a region close to the thickness direction of the current collector may include a carbon material having a specific surface area of 2500 m²/g or more and a conductive powder having a size of 50 to 300 nm.

The electrode active material layer formed in a region far away from the thickness direction of the current collector may include a carbon material having a specific surface area of 1500 to 1700 m²/g, a conductive powder having a size of 50 to 300 nm, and a powder having an electric conductivity of 10 to 10⁴ S/cm.

The carbon material may be one or more selected from a group consisting of activated carbon, carbon nanotube (CNT), graphite, carbon aerogel, polyacrylonitrile (PAN), carbon nanofiber (CNF), activated carbon nanofiber (ACNF), vapor growth carbon fiber (VGCF), and graphene.

The conductive powder having the size of 50 to 300 nm may be one or more selected from a group consisting of acetylene black, carbon black, super-P, and ketjen black.

The powder having the electric conductivity 10˜10⁴ S/cm may be a fibrous bundle and a sheet shape having a particle size of 50 to 300 nm.

The conductive powder having a size of 50 to 300 nm may be one or more selected from a group consisting of carbon nano tube (CNT), graphene, carbon nanofiber (CNF), and carbon fiber.

The exemplary embodiment of the present invention may provide an electrochemical capacitor including the electrode having the above-mentioned features.

The electrode may be one or both selected from a cathode and an anode.

### BRIEF DESCRIPTION OF THE DRAWINGS

FIG. 1 is a diagram showing a general structure of a supercapacitor.

FIG. 2 is a diagram showing an electrode structure according to an exemplary embodiment of the present invention.

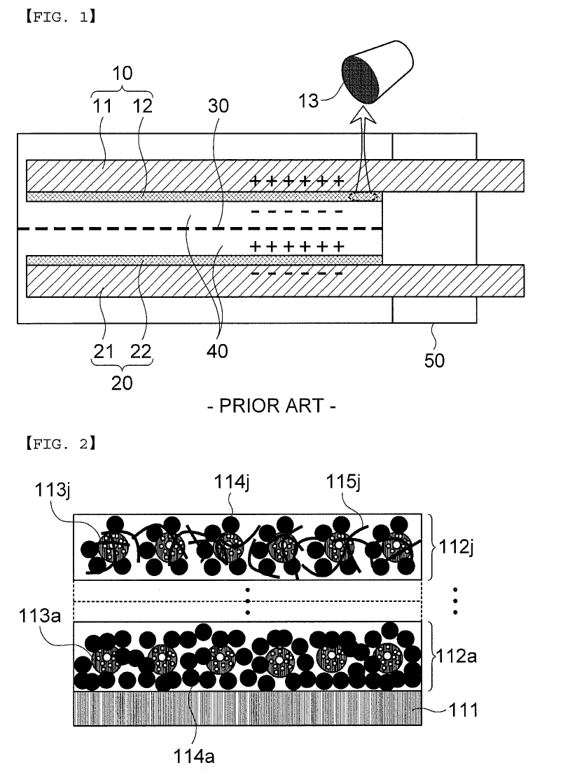

### DESCRIPTION OF THE PREFERRED EMBODIMENTS

Hereinafter, exemplary embodiments of the present invention will be described in more detail.

Terms used in the present specification are for explaining the embodiments rather than limiting the present invention. Unless explicitly described to the contrary, a singular form includes a plural form in the present specification. Also, used herein, the word “comprise” and/or “comprising” will be understood to imply the inclusion of stated shapes, figures, constituents, steps, operations and/or elements but not the exclusion of any other shapes, figures, constituents, steps, operations and/or elements.

The present invention relates to electrodes for electrochemical capacitors and electrochemical capacitors including the same.

An electrode according to an exemplary embodiment of the present invention includes an electrode active material layer having two layers or more formed on a current collector and the electrode active material layer has a gradient of the specific surface area value to the electric conductivity along a thickness direction of a current collector. That is, when the electrode active material layer is formed on the current collector, the electrode active material layer is controlled so that the electric conductivity and the specific surface area value of each electrode active material layer are different from each other.

In the exemplary embodiment of the present invention, ‘the electrode active material layer has the gradient of the specific surface area value to the electric conductivity along the thickness direction of the current collector’ means that the electric conductivity and the specific surface area value of each electrode active material layer formed along of the thickness direction of the current collector are changed, having a difference. However, this means that the difference between the electric conductivity and the specific surface area value is not changed, having a predetermined gradient according to each electrode active material layer but changed within a random range.

In detail, the electric conductivity of the electrode active material layer is increased and the specific surface area value is reduced as being far away from the current collector along the thickness direction of the current collector.

The gradient of the specific surface area value to the electric conductivity of the electrode active material layer may be achieved by making the kind of the electrode active material and the conductive material configuring the electrode active material layer different.

According to the exemplary embodiment of the present invention, the electrode active material layer formed at a close region in the thickness direction of the current collector may include a carbon material having a specific surface area of 2500 m²/g or more and a conductive powder having a size of 50 to 300 nm.

In the exemplary embodiment of the present invention, a reference of a close region and a far region from the thickness direction of the current collector may be the electrode active material layer that is formed at about 30 μm from the current collector. The electrode active material layer having the high specific surface area and the low electric conductivity may be formed in a region close to the current collector based on the thickness and the electrode active material layer having the small specific surface area and the high electric conductivity may be formed in the region far away from the current collector based on the thickness.

The carbon material having a specific surface area of 2500 m²/g or more may be used so that the electrode active material layer having the high specific surface area is formed at a close region in the thickness direction of the current collector. When the specific surface area of the carbon material is less than 2500 m²/g, the desired energy density may not be achieved, which is not preferable.

The carbon material may be one or more selected from a group consisting of activated carbon, carbon nanotube (CNT), graphite, carbon aerogel, polyacrylonitrile (PAN), carbon nanofiber (CNF), activated carbon nanofiber (ACNF), vapor growth carbon fiber (VGCF), and graphene.

As the carbon material having the high specific surface area, the activated carbon that is alkali-activated at a relatively low temperature of 400 to 700° C. may preferably be used. The alkali-activated carbon may be obtained by mixing and heat-treathing alkaline solutions such as KOH, NaOH, or the like, at the same temperature by using activated carbon materials such as palm tree, phenol resin, petroleum coke, or the like, and may be prepared a general alkali-activated conditions The activated carbon alkali-activated using the alkali solution has relatively dense fine pores formed from the surface to the inside thereof and has a high specific surface area of 2500 m²/g or more.

At this time, the added conductive material may include a conductive power having a size of 50 to 300 nm generally used. An detailed example of the added conductive material may include one or more selected from a group consisting of acetylene black, carbon black, supper-P, and ketjen black but is not limited thereto.

According to another exemplary embodiment of the present invention, the electrode active material layer formed in the region far away from the thickness direction of the current collector, that is, a thickness of about 30 μm or more may include a carbon material having a specific surface area of 1500 to 1700 m²/g, a conductive powder of a size of 50 to 300 nm, and a powder having electric conductivity of 10 to 10⁴ S/cm. That is, the exemplary embodiment of the present invention has the specific surface area slightly smaller than that of the electrode active material layer formed in the region close to the current collector, but supplements a problem in degrading the non-uniformity of the electric conductivity using the active material layer having excellent electric conductivity. Therefore, two or more conductive materials are used so as to have the slightly low specific surface area but the high electric conductivity.

In this case, the used carbon material may be a specific surface area of 1500 to 1700 m²/g. If the specific surface area is out of the range, there may be problem in that the electric conductivity may be reduced while a unit length of graphite crystallite having excellent electric conductivity is short. As the carbon material having the relatively low specific surface area, the activated carbon vapor-activated at a relatively high temperature of 800 to 1100° C. may be used. The activated carbon vapor-activated uses palm tree, phenol resin, petroleum coke, or the like, as raw materials and may use ones activated using vapor at high temperature. The surface of the activated carbon activated using the vapor is formed with pores and the specific surface area thereof is formed to be smaller than the activated carbon having the dense fine pores formed to the inside thereof.

At this time, as the added conductive material, a mixture of the generally used conductive power having a size of 50 to 300 nm and a powder having high electric conductivity may be used. A detailed example of the conductive powder may include one or more selected from a group consisting of acetylene black, carbon black, supper-P, and ketjen black, but is not limited thereto.

In addition, the powder having electric conductivity of 10˜10⁴ S/cm may have a fibrous bundle and a sheet shape having a particle size of 50 to 300 nm. An example of the conductive material may include one or more selected from a group consisting of carbon nanotube, grephene, carbon nanofiber, and carbon fiber.

Since the resistance of the general electrode active material layer is high as being far away from the thickness direction of the current collector and is low as being close thereto, the thicker the thickness of the electrode active material layer, the larger the capacitance becomes. When the thick electrode active material layer is used, the non-uniformity of the electric conductivity in the thickness direction of the electrode layer is more increased.

Therefore, in the exemplary embodiment of the present invention, in order to balance the capacitance and the resistance value of the electrode, the electrode active material layer is formed to have two layers or more but is formed to have the difference in the electric conductivity and the specific surface area value along the thickness of the current collector.

According to the exemplary embodiment of the present invention, the difference in the electric resistance between the electrode active material layers is in 10 S/cm. Therefore, both of the capacitance and the resistance value of the electrode are maintained to a desired level.

The electrode active material layer according to the exemplary embodiment of the present invention may be formed to have two layers or more and the number of layers is not particularly limited. The electrode active material layer is formed in several layers in some cases to uniformly maintain the resistance regardless of the thickness direction of the current collector.

Next, FIG. 2 shows a cross-sectional view of an electrode structure according to the exemplary embodiment of the present invention. Referring to FIG. 2, the active material layers (referred to as first active material layer (112a), . . . , and a tenth active material layer 112j) having two layers or more are formed on the current collector 111 and the active material layers may be formed to have the gradient of the specific surface area value to the electric conductivity.

That is, the first active material layer 112a formed in the region close to the current collector 111 may be made of an active material composition slurry including a carbon material 113a having the high specific surface area of 2500 m²/g or more, a conductive powder 114a having a size of 50 to 300 nm, or the like. The first active material layer 112a has a relatively low electric conductivity and thus, has a characteristic of small contact resistance.

Thereafter, different kinds of active material composition slurries are multi-layered on the first active material layer 112a at a time difference to form a second active material layer, a third active material layer, . . . , a tenth active material layer (not shown) 112j. The second active material layer formed on the first active material layer 112a uses the active material slurry composition having a relatively small specific surface area and a relatively high electric conductivity as compared with the first active material layer 112a so that it becomes important that each active material layer configuring the electrodes of the exemplary embodiment of the present invention has the gradient of the specific surface area value to electric conductivity.

In addition, the electrode active material layer having the high specific surface area and the low electric conductivity from the thickness direction of the current collector 111 to a thickness of about 30 μm may be formed and the electrode active material layer including two kinds of conductive materials having the low specific surface area of 1500 to 1700 m²/g and the high electric conductivity at the thickness or more may be formed.

Therefore, the tenth active material layer 112j formed in the region farthest away from the thickness direction of the current collector 111 may be made of an active material composition slurry including a carbon material 113j having the specific surface area of 1500 to 1700 m²/g, a conductive powder 114j having a size of 50 to 300 nm, and a powder 115 j having a high electric conductivity in a fibrous bundle or a sheet shape.

The high-density supercapacitor cell in which the difference in resistance between a portion close to the thickness direction of the current collector and a portion far way therefrom through the electrode structure may be minimized and the energy density is high may be manufactured.

The electrode active material composition according to the exemplary embodiment of the present invention may include additives including a binder resin within a range that does not damage dispersibility and flowability of the electrode active material compositions according to the exemplary embodiment of the present invention in addition to the electrode active material and the conductive material.

An example of the binder resin may include one or more selected from fluorine based resin such as polytetrafluoro ethylene (PTFE), polyvinylidenefluoride (PVdF); thermoplastic resin such as polyimide, polyamideimide, polyethylene (PE), polypropylene (PP), or the like; cellulose based resin such as carboxy methyl cellulose (CMC), or the like; rubber based resin, such as styrene-butadiene rubber (SBR), or the like, and a mixture thereof, but is not particularly limited thereto. Therefore, all the binder resins used for the electrochemical capacitor may be used.

The exemplary embodiment of the present invention may provide the electrochemical capacitors including the electrodes.

The electrode according to the exemplary embodiment of the present invention may be used as any one or all selected from the cathodes and/or the anodes of the electrochemical capacitors.

The cathode and the anode may be manufacture by applying the electrode active material composition on the cathode and anode current collector at a predetermined thickness and the method of applying the electrode active material composition is not particularly limited.

In addition, a forming sheet that is formed in a sheet shape or is extruded in an extrusion manner by using a mixture of the electrode active material, the conductive material, and a solvent as the binder resin may be bonded to the current collector by using a conductive adhesive.

The cathode current collector may use all the materials used for an electric double layer capacitor or a lithium ion battery according to the related art, for example, one or more selected from a group consisting of aluminum, stainless steel, titanium, tantalum, and niobium. Among others, aluminum may be preferably used. In addition, the current collector having holes penetrating through front and rear surfaces, such as a foil of the metal, an etched metal foil, or an expanded metal, a punching metal, a net, a foam, or the like, may be used. The current collector may have a thickness of about 10 to 300 μm.

In addition, the anode current collector according to the exemplary embodiment of the present invention may use all the materials used for the electric double layer capacitor or the lithium ion battery according to the related art, for example, stainless steel, copper, nickel, and an alloy thereof, or the like. Among those, copper is preferable. In addition, ones having holes penetrating through front and rear surfaces, such as a foil of the metal, an etched metal foil, or an expanded metal, a punching metal, a net, a foam, or the like, may be used. The current collector may have a thickness of about 10 to 300 μm.

A separation membrane according to the exemplary embodiment of the present invention may use all the materials used for the electric double layer capacitor or the lithium ion battery according to the related art, for example, may include a fine porous film manufactured from one or more polymer selected from a group consisting of polyethylene (PE), polypropylene (PP), polyvinylidenefluoride (PVDF), polyvinylidene chloride, polyacrylonitrile (PAN), polyacrylamide (PAAm), polytetrafluoro ethylene (PTFE), polysulfone, polyethersulfone (PES), polycarbonate (PC), polyaimide (PA), polyimide (PI), polyethylene oxide (PEO), polypropylene oxide (PPO), cellulose based polymer, and polyacryl based polymer. In addition, a multi-layer film formed by polymerizing the porous film may also be used. Among those, the cellulose based polymer may be preferably used.

The thickness of the separation membrane is preferably about 15 to 35 μm, but is not limited thereto.

An electrolytic solution may include an organic electrolytic solution including a non-lithium salt such as TEABF₄, TEMABF₄, or the like, or one or more lithium salt selected from a group consisting of LiPF₆, LiBF₄, LiCLO₄, LiN(CF₃SO₂)₂, CF₃SO₃Li, LiC(SO₂CF₃)₃, LiAsF₆ and LiSbF₆ or a mixture thereof.

An example of the solvent of the electrolytic solution may include one or more selected from a group consisting of ethylene carbonate, propylene carbonate, dimethyl carbonate, ethylmethyl carbonate, sulforan, and dimethoxy ethane, but is not limited thereto. The electrolytic solution of a combination of solute and solvent has high withstanding voltage and high electric conductivity. A concentration of the electrolyte in the electrolytic solution may be 0.1 to 2.5 mol/L and 0.5 to 2 mol/L.

As a case (exterior material) of the electrochemical capacitor according to the exemplary embodiment of the present invention, a laminate film including aluminum generally used for the secondary battery and the electric double layer capacitor may be preferably used, but is not limited thereto.

Hereinafter, the exemplary embodiment of the present invention will be described in detail. The following exemplary embodiment is only an example of the present invention and the scope of the present invention is not construed as being limited to these exemplary embodiments. In addition, the following exemplary embodiments are illustrated using specific compounds, but it is apparent to those skilled in that art that equivalent or similar effect can be obtained even in the case of using these equivalents.

### Example 1

### Manufacture of Electrode Including Electrode Active Material Layer Having Two Layers or More

In the case of the electrode material layer (first electrode active material layer) close to the current collector, 85 g of activated carbon (specific surface area of 2550 m²/g) alkali-activated, 18 g of Super-P as the conductive material, 3.5 g of CMC as the binder, 12.0 g of SBR, and 5.5 g of PTFE were mixed and agitated in 225 g of water to prepare the electrode active material slurry. The prepared active material slurry was applied on the aluminum etching foil having a thickness of 20 μm by using a comma coater and was temporarily dried. In this case, a cross section thickness of the first electrode active material layer was fixed at 30 μm.

In the case of the second electrode active material layer to be applied on the first electrode active material layer, 75 g of activated carbon (specific surface area of 1550 m²/g) vapor-activated, 13 g of Super-P as the conductive material, 8 g of carbon nanotube (CNT, electric conductivity of 103 S/cm) in a fibrous bundle shape, 4.5 g of CMC as the binder, 12.0 g of the SBR, and 5.5 g of PTFE were mixed and agitated in 255 g of water to prepare the electrode active material slurry.

After the prepared active material slurry was applied on the first electrode active material layer by using the comma coater and was temporarily dried, the electrode size was cut so as to be 50 mm×100 mm. The cross section thickness of the second electrode active material layer was fixed at 30 μm. The total cross-section thickness of the electrode was set to be 60 μm and the electrode was manufactured by drying for 48 hours under the vacuum state of 120° C., followed by the assembling of the cells.

### Comparative Example 1

85 g of activated carbon (specific surface area of 2550 m²/g) alkali-activated, 18 g of Super-P as the conductive material, 3.5 g of CMC as the binder, 12.0 g of SBR, and 5.5 g of PTFE were mixed and agitated in 225 g of water to prepare the electrode active material slurry.

After the prepared active material slurry was applied on the aluminum etching foil having a thickness of 20 μm by using the comma coater and was temporarily dried, the electrode size was cut so as to be 50 mm×100 mm. The cross-section thickness of the electrode was 60 μm. The electrode was manufactured by drying for 48 hours under the vacuum state of 120° C., followed by the assembling of the cell.

### Example 2, Comparative Example 2

### Manufacture of Electrochemical Capacitor

The manufactured electrode was used as the cathode and the anode, the separator (TF4035 from NKK, cellulose base separator) was inserted between the cathode and the anode, the electrolyte was impregnated and put in the laminate film case and sealed to prepare the electrochemical capacitor.

### Experimental Example

### Evaluation of Capacitance of Electrochemical Capacitor Cell

The capacitance of the final cycle was measured by being charged up to 2.5V at a current density of 1 mA/cm² with constant current-constant voltage, being maintained for 30 minutes, and then being discharged three times with constant current of 1 mA/cm² under a constant temperature condition of 25° C. and the results were shown in the following Table 1.

In addition, the resistance characteristics of each cell was measured by ampere-ohm meter and impedance spectroscopy and the results were shown in the following Table 1.

TABLE 1

| | Initial Capacity | Resistance Characteristic |
|---|---|---|
| | Characteristic (F) | (AC ESR, mΩ) |
| Comparative Example 2 | 10.55 | 19.11 |
| Example 2 | 11.08 | 12.05 |

As can be appreciated from the results of the following Table 1, the capacitance of Comparative Example 2 that is the electrochemical capacitor (EDLC cell) including the electrode according to Comparative Example 1 including the electrode active material layer of the single layer by using the general electrode active material slurry composition was shown as 10.55 F. In this case, the resistance value was 19.11 mΩ.

On the other hand, the capacitance of Example 2 that is the electrochemical capacitor (EDLC cell) including the electrode according to Example 1 including the electrode active material layer having two layers by mixing ones in which a kind of the activated carbon, a content of the conductive material, and characteristics are different in as the exemplary embodiment of the present invention was shown as 11.08 F. In this case, the resistance value was 12.05 mΩ.

From the results, the electrode minimizing the difference in resistance within the electrode per a unit volume through the multi-layer electrode active material structure as described above may be manufactured and the cells having excellent conductivity, low resistance, and high output characteristics may be manufactured.

As set forth above, the exemplary embodiments of the present invention can manufacture the electrodes having the gradient of the specific surface area value to the electric conductivity along the thickness direction of the current collector by forming the electrode active material layer having compositions in which the kind of the electrode active material and the conductive material are different along the thickness direction of the current collector. The exemplary embodiments of the present invention can increase the capacitance of the electrochemical capacitor including the electrode and reduce the electric resistance thereof, by appropriately controlling the resistance and capacitance value of the electrode.

While the present invention has been shown and described in connection with the embodiments, it will be apparent to those skilled in the art that modifications and variations can be made without departing from the spirit and scope of the invention as defined by the appended claims.

What is claimed is:

1. An electrode, comprising:
an electrode active material layer having two layers or more formed on a current collector,
wherein the electrode active material layer has a gradient of the specific surface area value to the electric conductivity along a thickness direction of the current collector.

2. The electrode according to claim 1, wherein a gradient is provided so that the electric conductivity of the electrode active material layer is increased and the specific surface area value is reduced, as being far away from the thickness direction of the current collector.

3. The electrode according to claim 1, wherein the gradient of the specific surface area value to electric conductivity of the electrode active material layer is based on an electrode active material layer formed at about 30 μm from the current collector along the thickness direction of the current collector.

4. The electrode according to claim 1, wherein the electrode active material layer formed in a region close to the thickness direction of the current collector includes a carbon material having a specific surface area of 2500 m²/g or more and a conductive powder having a size of 50 to 300 nm.

5. The electrode according to claim 1, wherein the electrode active material layer formed in a region far away from the thickness direction of the current collector includes a carbon material having a specific surface area of 1500 to 1700 m²/g, a conductive powder having a size of 50 to 300 nm, and a powder having an electric conductivity of 10 to 10⁴ S/cm.

6. The electrode according to claim 4, wherein the carbon material is one or more selected from a group consisting of activated carbon, carbon nanotube (CNT), graphite, carbon aerogel, polyacrylonitrile (PAN), carbon nanofiber (CNF), activated carbon nanofiber (ACNF), vapor growth carbon fiber (VGCF), and graphene.

7. The electrode according to claim 5, wherein the carbon material is one or more selected from a group consisting of activated carbon, carbon nanotube (CNT), graphite, carbon aerogel, polyacrylonitrile (PAN), carbon nanofiber (CNF), activated carbon nanofiber (ACNF), vapor growth carbon fiber (VGCF), and graphene.

8. The electrode according to claim 4, wherein the conductive powder having the size of 50 to 300 nm is one or more selected from a group consisting of acetylene black, carbon black, super-P, and ketjen black.

9. The electrode according to claim 5, wherein the conductive powder having the size of 50 to 300 nm is one or more selected from a group consisting of acetylene black, carbon black, super-P, and ketjen black.

10. The electrode according to claim 5, wherein the powder having the electric conductivity 10˜10⁴ S/cm is a fibrous bundle and a sheet shape having a particle size of 50 to 300 nm.

11. The electrode according to claim 8, wherein the powder is one or more selected from a group consisting of carbon nano tube (CNT), graphene, carbon nanofiber (CNF), and carbon fiber.

12. An electrochemical capacitor including the electrode according to claim 1.

13. The electrochemical capacitor according to claim 12, wherein the electrode is one or both selected from a cathode and an anode.
